(19) United States
(12) Patent Application Publication
(10) Pub. No.: US 2014/0032114 A1
(43) Pub. Date: Jan. 30, 2014

(54) Navigation Redirect Using CMAS Emergency Alerts

(71) Applicant: TeleCommunication Systems, Inc., Annapolis, MD (US)

(72) Inventors: Mark A. Titus, Annapolis, MD (US); Dara Ung, Harwood, MD (US); Theresa Whitehurst, Raleigh, NC (US); Jay Whitehurst, Raleigh, NC (US); Austin Klahn, Commerce City, CO (US); Brant Clark, Mt. Baldy, CA (US)

(73) Assignee: TeleCommunication Systems, Inc., Annapolis, MD (US)

(21) Appl. No.: 13/954,517

(22) Filed: Jul. 30, 2013

Related U.S. Application Data
(60) Provisional application No. 61/725,776, filed on Nov. 13, 2012.
(60) Provisional application No. 61/677,094, filed on Jul. 30, 2012.
(60) Provisional application No. 61/678,743, filed on Aug. 2, 2012.
(60) Provisional application No. 61/678,747, filed on Aug. 2, 2012.

(51) Int. Cl. G01C 21/34

(52) U.S. Cl. CPC G01C 21/3453
USPC 701/537; 340/539.22

(57) ABSTRACT

A navigation system integrated with knowledge of active emergency alerting system alert data and up to date Doppler weather radar data, to provide a visual representation of an alert area and/or current weather patterns on a map, and to automatically navigate a subscriber device away from an affected area, e.g., an alert area, an area under severe weather. The inventive navigation system displays NEXRAD Doppler weather radar data on a map by integrating a NEXRAD feed into the map and allowing a user to enable/disable the NEXRAD feed as a map overlay. The inventive navigation system also automatically routes or reroutes a subscriber device to avoid areas under severe weather. The navigation system is also integrated with a conventional CMSP gateway in an emergency alerting system to provide: a visual representation of an alert area on a map and to automatically route/reroute a subscriber device around an alert area.

The present invention claims priority from U.S. Provisional No. 61/677,094, filed Jul. 30, 2012, entitled “Navigation Redirect Using CMAS Emergency Alerts”, and from U.S. Provisional No. 61/678,743, filed Aug. 2, 2012, entitled “Utilize Information from Emergency Mass Notification Service for Routing Alert”, and from U.S. Provisional No. 61/678,747, filed Aug. 2, 2012, entitled “Overlay NEXRAD Data on Map View and Navigation View Screens”, and from U.S. Provisional No. 61/725,776, filed Nov. 13, 2012, entitled “Utilizing CMAS Emergency Alerts and Doppler Weather for MAP Display and Navigation Redirect”, the entirety of all of which are expressly incorporated herein by reference.

### BACKGROUND OF THE INVENTION

1. Field of the Invention

This invention relates generally to elements of using both CMAS notifications and Doppler weather radar for location, navigation, mapping, and mobile alerts.

2. Background of Related Art

On Jun. 28, 2012, a Commercial Mobile Alert System (CMAS) was launched by the Department of Homeland Security (DHS). A Commercial Mobile Alert System (CMAS) is an emergency alerting technology that broadcasts alerts to subscriber devices located in geographically targeted areas. A geo-targeted alert alerts subscribers to imminent threats to life and/or property occurring in or near their current location.

A conventional geotargeted alert defines the following key pieces of information: an alert type (e.g., tornado warning, flash flood, etc.), an alert area (i.e., a target area or area of impact), an alert expiration time/date, and a recommended action, e.g., seek shelter, evacuate the area, etc. A geotargeted alert is broadcast to all subscriber devices located in an alert area defined therein.

The Commercial Mobile Alert System (CMAS) does not require mobile identification information or device location information to send alerts. Moreover, the Commercial Mobile Alert System (CMAS) is based on cellular communication technology and designed specifically for use on cell phones.

Unfortunately, a conventional geotargeted alert does not include a visual representation of an alert area, which may be helpful to a user when, e.g., attempting to evacuate an alert area. Moreover, a geotargeted alert is only distributed to subscriber devices located within the boundaries of a corresponding alert area. Thus, a mobile subscriber device located outside an alert area, and actively navigating toward a destination, may unknowingly be headed into the path of an active alert area, e.g., a tornado, a flash flood, etc.

Certain weather content providers (e.g. weatherchannel.com) provide weather-related text alerts to subscriber devices, to alert subscribers to potentially dangerous weather events (e.g., extreme weather conditions, snow, hail, etc.) occurring in an area. Unfortunately, weather-related text alerts are broadcast to subscriber devices based on a set of pre-registered zip code values, as opposed to a device's current location. Hence, weather-related text alerts do not alert subscribers to weather events occurring along a navigated route. Consequently, mobile devices actively navigating toward a destination may unknowingly be headed into the path of severe weather, which could pose a hazardous driving situation, especially in the case of heavy rain, ice, or snow.

Existing navigation technology informs a subscriber device of potential traffic delays and enables a subscriber device to select alternate routes to avoid traffic. However, a mobile subscriber device may also wish to be alerted to other potential occurrences along a navigated route. For instance, a subscriber device may wish to be notified of current weather patterns and/or any potential threats to safety occurring along a navigated route. A subscriber device may also want the option to reroute around a potentially dangerous event occurring along a navigated route.

### BRIEF DESCRIPTION OF THE DRAWINGS

Features and advantages of the present invention will become apparent to those skilled in the art from the following description with reference to the drawings, in which:

FIG. 1 depicts a conventional process for geographically targeting an alert to a subscriber device.

FIG. 2 depicts an exemplary navigation route that intersects an active alert area, in accordance with the principles of the present invention.

FIG. 3 depicts exemplary rerouting around an active alert area, in accordance with the principles of the present invention.

FIG. 4 depicts an exemplary process for performing navigation redirect around an active alert area, in accordance with the principles of the present invention.

FIG. 5 depicts an exemplary navigation map displayed on a mobile device in normal map view when a “radar view” option is enabled, in accordance with the principles of the present invention.

FIG. 6 shows an exemplary navigation route displayed on a map on a mobile device in normal map view with a “radar view” option enabled, in accordance with the principles of the present invention.

### SUMMARY

A navigation system that automatically displays severe weather conditions and/or areas of imminent threat to life and/or property on a map, and that automatically routes or reroutes a subscriber device away from areas under severe weather and/or imminent threat, comprises a navigation system integrated with knowledge of active emergency alert system alert data and up to date Doppler weather radar data.

In accordance with the principles of the present invention, a navigation system displays NEXRAD Doppler weather radar data on a map by integrating a NEXRAD feed into the map and allowing a user to enable/disable the NEXRAD feed as a map overlay. The inventive navigation system also provides options to pan and zoom a map display to view weather patterns in other areas of the United States.

In accordance with the principles of the present invention, the inventive navigation system automatically routes a subscriber device around areas under severe weather, when a route to a requested destination is intersecting a severe weather system. Likewise, the inventive navigation system provides an alternate route around areas under severe weather, when a subscriber device is in an active navigation session and a current route is intersecting a severe weather system.

In accordance with the principles of the present invention, the inventive navigation system is additionally integrated with a conventional commercial mobile service provider (CMSP) gateway in an emergency alerting system (e.g. a commercial mobile alert system (CMAS)) to provide: a visual representation of an alert area (i.e., an area of imminent threat to life and/or property) on a map, a nature of a corresponding alert, (e.g. a flash flood, tornado, hazardous waste spill, severe thunderstorm, etc.), a route around the alert area when a route to a requested destination intersects the alert area, and an alternate route around the alert area, when a subscriber device is in an active navigation session and a current route is intersecting the alert area.

### DETAILED DESCRIPTION OF ILLUSTRATIVE EMBODIMENTS

The present invention provides a navigation system integrated with knowledge of active emergency alert system (e.g. a commercial mobile alert system (CMAS)) alert data and up to date Doppler weather radar data, to provide a visual representation of active alert areas (i.e., areas of imminent threat to life and/or property) and/or current weather patterns on a map, and to automatically navigate a subscriber device away from any affected areas, e.g., active alert areas, areas under severe weather, etc.

Conventional emergency alerting systems use cell broadcast technology to broadcast alert messages (similar to text messages) to subscriber devices located in geographically targeted areas. Geo-targeted alert messages alert subscribers to imminent threats to life and/or property occurring in or near their current location.

An alert area in a geotargeted alert is defined by a set of (X,Y) coordinates containing latitude and longitude ordered pairs that construct a polygon. A geotargeted alert is broadcast to all subscriber devices located within coverage range of cell sites located in an alert area.

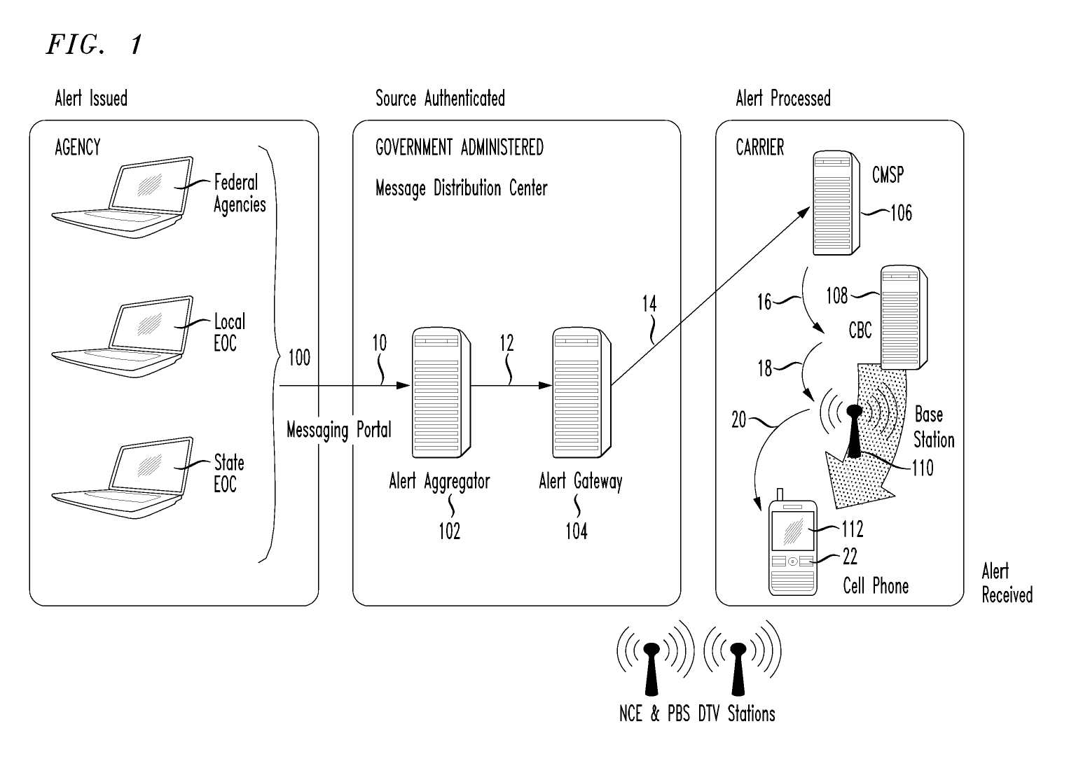

FIG. 1 depicts a conventional process for geographically targeting an alert to a subscriber device.

As depicted in step 10 of FIG. 1, an alert defining the following key pieces of information is generated by an alert originator 100 and passed to a government administered alert aggregator 102: an alert type (e.g., tornado warning, flash flood, etc.), an alert area (i.e., target area or area of impact), an alert expiration time/date, and a recommended action, e.g., seek shelter, evacuate the area, etc.

As shown in step 12 of FIG. 1, the alert aggregator 102 authenticates and processes the alert (i.e. authenticates the message source, validates the message format, reduces the message for a network carrier, converts the message in to an appropriate format, etc.) and then passes the alert to a government administered alert gateway 104.

As portrayed in step 14, the alert gateway 104 forwards the alert to a commercial mobile service provider (CMSP) gateway (i.e. a gateway to a wireless network) 106 in an emergency alerting system.

The CMSP gateway 106 processes parameters received in the alert and formats the alert for delivery to cell sites 110 located in the alert area defined in the alert. In step 16, the CMSP gateway 106 sends the alert and geotargeted cell site locations (i.e. addresses of participating cell sites located in the alert area defined in the alert) 110 to a cell broadcast center (CBC) 108.

In step 18, the cell broadcast center (CBC) 108 broadcasts the alert to geotargeted cell site locations 110.

As depicted in step 20, the alert is received at each destination cell site 110 and subsequently broadcast to affiliated subscriber devices 112.

In step 22, the alert is received on all subscriber devices 112 within coverage range of the geotargeted cell sites 110.

Mobile users that receive geotargeted alerts (e.g. CMAS alerts) and have a navigation/mapping application available on a device may wish to view an alert area on a map. For instance, a visual representation of an alert area may be helpful to a user that is attempting to evacuate an alert area. Unfortunately, geotargeted alerts do not provide a visual representation of an alert area, nor do existing navigation technologies take into account or consider active alert data when displaying a map or when determining/monitoring a navigation route.

Furthermore, geotargeted alerts are only distributed to subscriber devices located within coverage range of cell sites located in an alert area. Consequently, subscriber devices that are located outside a coverage range of cell sites located in an alert area, and actively navigating toward a destination, may unknowingly be headed into the path of an active alert area, e.g., a tornado, a flash flood, etc., which could pose an imminent threat to a subscriber's life and/or property.

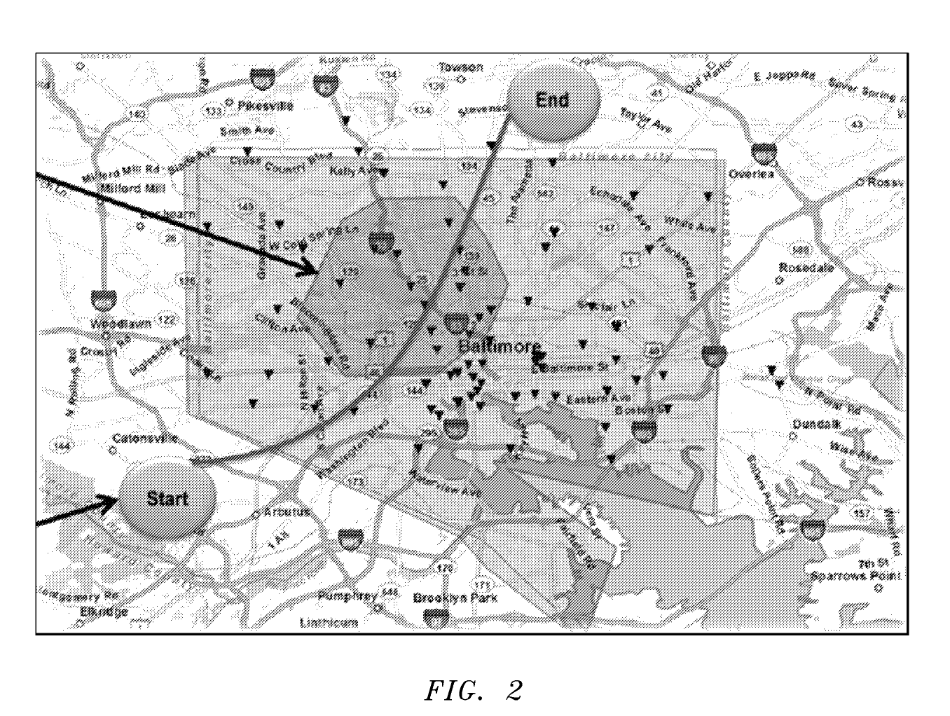

FIG. 2 depicts an exemplary navigation route that intersects an active alert area, in accordance with the principles of the present invention.

As depicted in FIG. 2, a navigation system may route 200 a subscriber device directly through an active alert area 210.

In accordance with the principles of the present invention, the inventive navigation system displays active alert areas, as defined by a conventional emergency alerting system (e.g. a CMAS) on a map, to give users a geospatial awareness of an impacted alert area. The inventive navigation system also automatically routes or reroutes a subscriber device away from a geographically targeted alert area and out of harm's way, when a subscriber device is in a navigation session and actively routing.

In accordance with the principles of the present invention, the inventive navigation system is integrated with cell broadcast/emergency alerting technology (e.g. a commercial mobile alert system (CMAS)) to provide: a visual representation of an alert area (i.e. an area of imminent threat to life and/or property) on a map, a nature of a corresponding alert, (e.g. a flash flood, tornado, hazardous waste spill, severe thunderstorm, etc.), a route around the indicated alert area when a route to a requested destination intersects the alert area, and an alternate route around the alert area, when a subscriber device is in an active navigation session and a current route intersects the alert area.

The present invention requires system integration between a commercial mobile service provider (CMSP) gateway in an emergency alerting system and a navigation system. In accordance with the principles of the present invention, a commercial mobile service provider (CMSP) gateway forwards alert data for an alert broadcast by an emergency alerting system to the inventive navigation system. The navigation system then stores active alert data in an alert database and displays a visual representation of an alert area defined therein on a map. Providing a visual representation of an alert area on a map enables a user to determine when a navigation route is intersecting an area of imminent threat or danger.

A visual representation of an alert area preferably depicts coverage areas emitted by cell sites located in that alert area. In accordance with the principles of the present invention, the inventive navigation system preferably references a cell site database to approximate coverage areas emitted by cell sites (other methods may also be used to approximate cell site coverage areas). Approximated coverage areas are then displayed as an overlap on a map. The navigation system also preferably indicates an alert type, e.g., tornado, flash flood, etc., for each alert area displayed on a map.

In addition to displaying active alert areas on a map, a navigation system integrated with knowledge of active emergency alerting system alert data can also automatically alter navigation routes to avoid areas of imminent threat and/or danger, thus redirecting in-transit vehicles and their occupants out of harm's way. In accordance with the principles of the present invention, the inventive navigation system automatically routes a subscriber device around an alert area defined in an alert, when a navigation request is received after that alert is broadcast. Moreover, the navigation system automatically provides an alternate route around an alert area when a subscriber device is in an active navigation session and a current route is intersecting the alert area. The inventive navigation system also preferably informs a subscriber device when a navigation route is calculated to avoid an alert area. For instance, the navigation system may show a route on a map along with an active alert area, a written message, an audio message, or any combination thereof, to show that a route has been calculated to avoid the alert area.

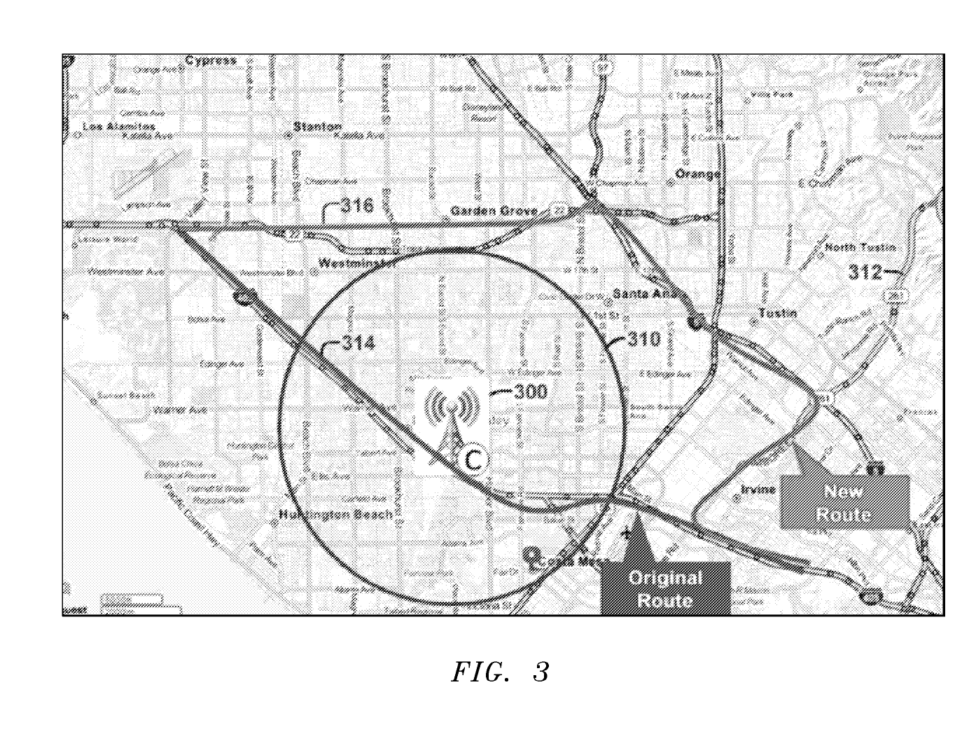

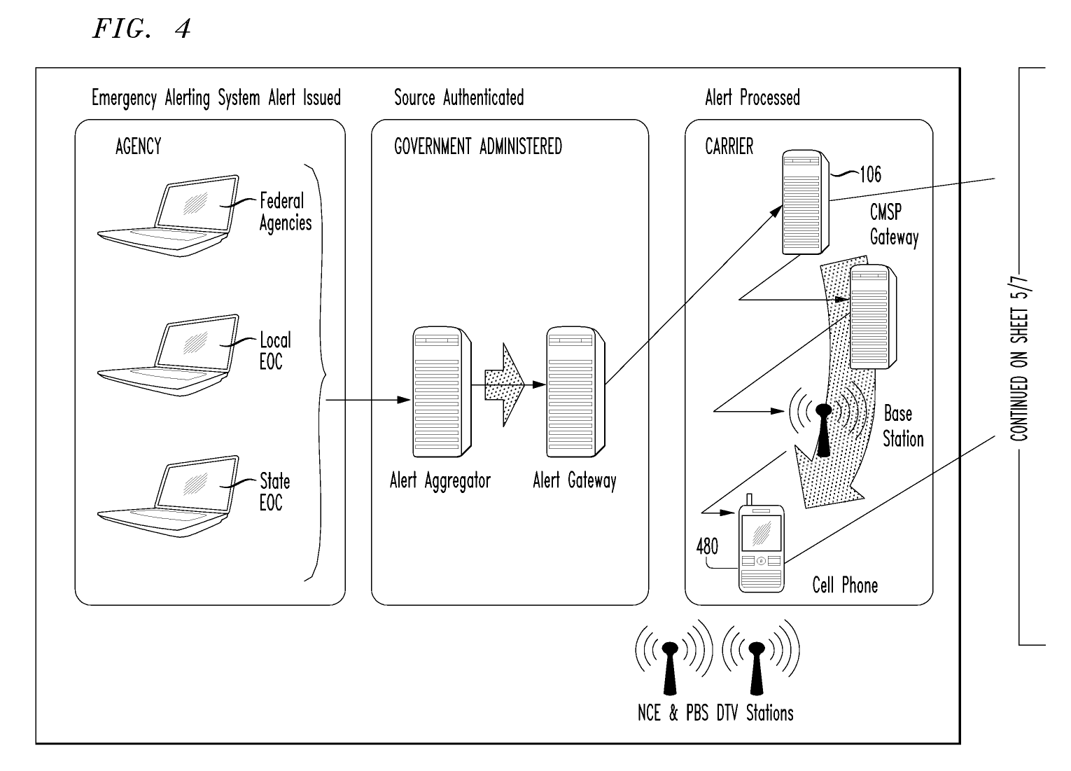

FIG. 3 depicts exemplary rerouting around an active alert area, in accordance with the principles of the present invention.

In particular, FIG. 3 portrays an example wherein a navigation system has intercepted an emergency alert notification containing a flood warning for an alert area covered by a cell site C 300. As portrayed in FIG. 3, the navigation system responds to the alert by displaying an overlay of a coverage area 310 emitted by cell site C 300 on a map 312. In addition, since the alert area (the area covered by cell site C 300) 310 is intersecting a current navigation route 314, the inventive navigation system automatically calculates a new route 316 to avoid the active alert area 310 and displays the new route 316 on the map 312.

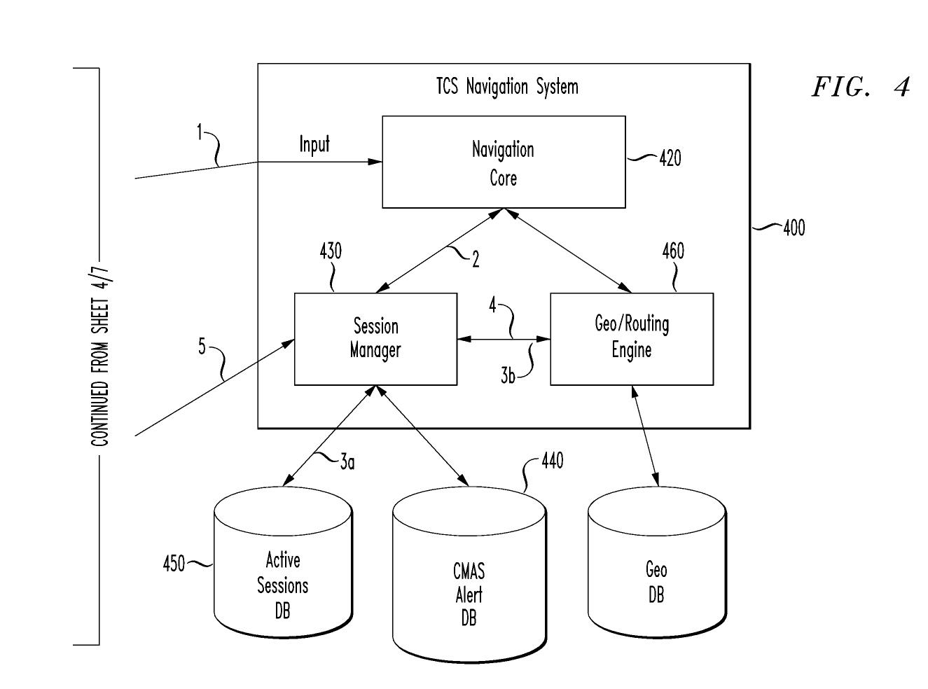

FIG. 4 depicts an exemplary process for performing navigation redirect around an active alert area, in accordance with the principles of the present invention.

As depicted in step 1 of FIG. 4, a Commercial Mobile Service Provider (CMSP) gateway 106 receives an alert during conventional emergency alerting system alert processing, and forwards alert information defined therein to a navigation system 400. Forwarded alert information preferably includes: an alert type, an alert expiration, a recommended action, and an alert area (i.e. a polygon shape file (late, long)).

In step 2, a conventional navigation core 420 in the navigation system 400 instructs a conventional session manager 430 to update an alert database 440 with alert information received in step 1.

In steps 3a and 3b, the session manager 430 queries a conventional active sessions database 450 and interacts with a conventional geo/routing engine 460 to determine if an alert area defined in the alert received in step 1 is intersecting any active navigation sessions in use on a navigating subscriber device 480.

If the session manager 430 determines that the alert area defined in the alert received in step 1 is not intersecting an active navigation session, then route recalculation is not required.

Alternatively, if the session manager 430 determines that the alert area defined in the alert received in step 1 is intersecting an active navigation session, then the session manager 430 instructs the geo/routing engine 460 to reroute the active navigation session to avoid the alert area. The geo/routing engine 460 then returns updated route information to the session manager 430, as shown in step 4.

In step 5, the session manager 430 updates the navigation session currently active on the navigating subscriber device 480 with revised route information.

Note that the emergency alerting system (e.g. commercial mobile alert system (CMAS)) 470 and the navigation system 400 depicted in FIG. 4 are processing asynchronously and independently of one another. More particularly, once the CMSP gateway 106 forwards alert data to the inventive navigation system 400, the emergency alerting system 460 continues processing alert data in a conventional manner, independent of the navigation system 400.

The present invention displays areas of imminent danger on a map to help users determine a closest ‘safe’ area and to allow users to better avoid alert areas that are intersecting a current path of travel.

Doppler weather radar is a conventional tool that reads and predicts weather patterns. Next-Generation Radar (NEXRAD) Doppler weather radar was installed in 1990 and now consists of 159 stations, currently operated by the National Weather Service. NEXRAD detects precipitation and atmospheric movement (wind) and returns data that, when processed, can display a mosaic map that depicts patterns of precipitation and movement.

Certain weather content providers use Doppler weather radar data to send weather-related text alerts to subscriber devices. However, weather-related text alerts are conventionally sent to subscriber devices based on a set of pre-registered zip code values, as opposed to a device's current location. Moreover, conventional navigation technologies do not take into account or consider Doppler weather radar data when displaying, determining, or monitoring a navigation route. Consequently, a subscriber device actively navigating toward a destination may unknowingly be headed into the path of severe weather, which could pose a hazardous driving situation, especially in the case of heavy rain, ice, or snow.

In accordance with the principles of the present invention, the inventive navigation system 400 is integrated with NEXRAD Doppler weather radar data to provide a visual representation of weather patterns occurring about a subscriber device's current location on a map. Doppler weather radar data is preferably displayed on a map alongside active emergency alerting system 470 alert data.

In accordance with the principles of the present invention, the inventive navigation system 400 also automatically routes or reroutes a subscriber device away from severe weather, when a subscriber device is in a navigation session and actively routing. The inventive navigation system additionally provides options to pan and zoom a map display to show weather patterns in other areas of the United States.

In accordance with the principles of the present invention, a navigation system 400 displays NEXRAD Doppler weather radar data on a map by integrating a NEXRAD feed into the map, and allowing a user to enable/disable the feed as a map overlay.

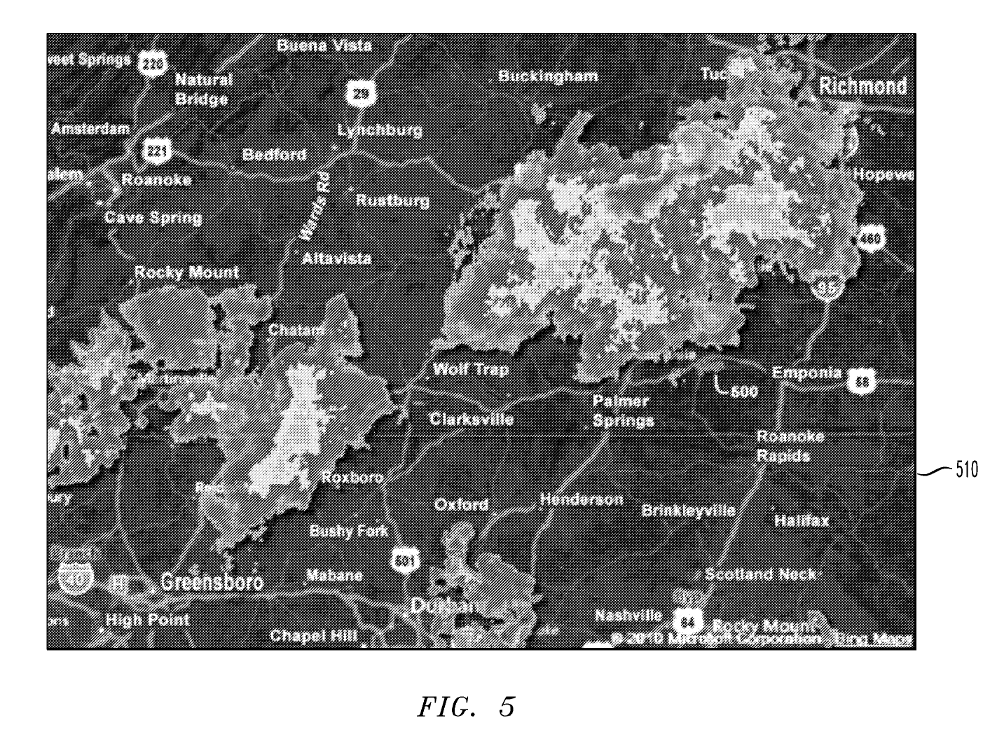

FIG. 5 depicts an exemplary navigation map displayed on a mobile device in normal map view with a “radar view” option enabled, in accordance with the principles of the present invention.

As depicted in FIG. 5, when a “radar view” option is enabled on a navigation system 400, Doppler weather radar data is displayed on a map 510 as a map overlay 500.

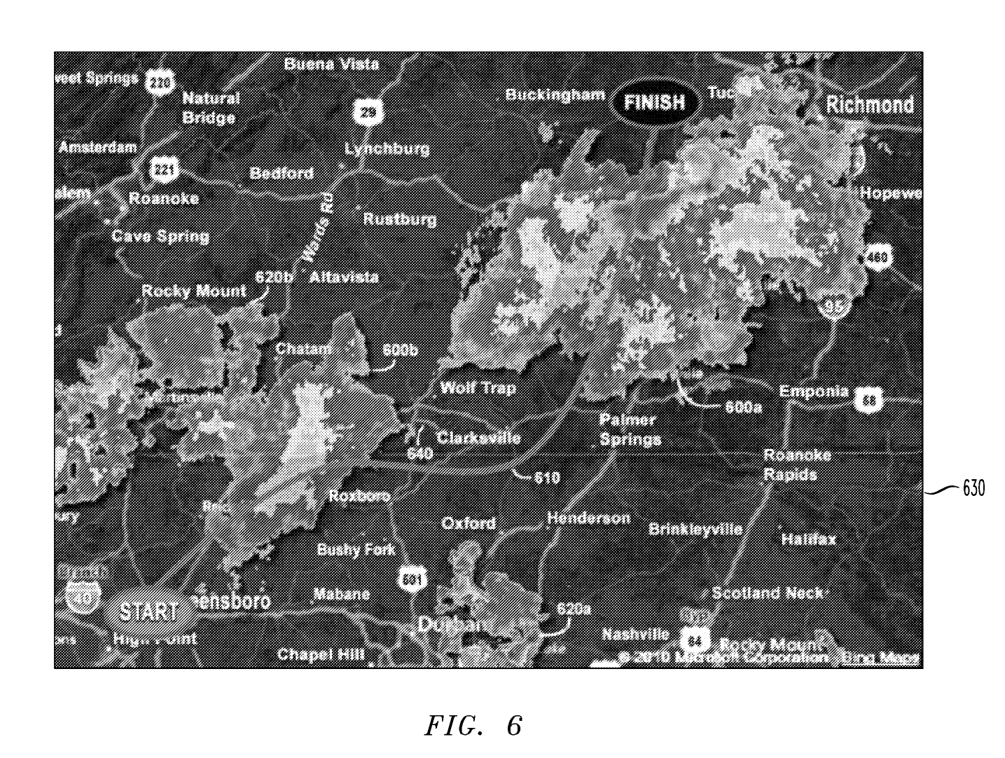

FIG. 6 shows an exemplary navigation route displayed on a map on a mobile device in normal map view with a “radar view” option enabled, in accordance with the principles of the present invention.

In particular, as a subscriber device travels, the inventive navigation system 400 displays weather content 600a and 600b along the device's current route 610 and weather content 620a and 620b in areas surrounding the device's current route 610 on a map 630.

Displaying Doppler weather radar data 600 and 620 on a map 630 enables users to understand what type of weather conditions may be expected when navigating to a particular destination. In some cases, a user may decide to delay their travel based on current weather conditions, or plan for adding additional time, if, e.g., a large weather system is intersecting a navigated route.

For instance, a user navigating the route 610 depicted in FIG. 6 may decide to stop in Clarksville 640 for lunch to let the severe weather system 600a intersecting the route 610 to pass.

The present invention integrates a navigation system 400 with emergency alerting system 470 alert data and Doppler weather radar data to enable a navigation system 400 to display areas of imminent threat on a map and to redirect in-transit vehicles and their occupant's out of harm's way.

The present invention is beneficial in areas that have frequent road closures due to flooding. For example, in areas of Nevada, heavy rains often close local and major thoroughfares for hours. The present invention is also helpful in mountainous areas where snowfall tends to close roads. For example, only a few inches of snowfall on the “Grapevine” on the I-5 causes the freeway to close for hours, whereas heavier snow causes the road to close for days.

The present invention has particular applicability to customers of navigation systems and is not limited to use on mobile phones. Key benefits of intelligent navigation integrated with emergency alert notification data and Doppler weather radar data can be translated into an improved user experience that can ultimately save lives.

The present invention additionally has particular applicability to navigation applications embedded in a mobile operating system and on cellular/wireless devices for providing in-vehicle and/or pedestrian navigation.

While the invention has been described with reference to the exemplary embodiments thereof, those skilled in the art will be able to make various modifications to the described embodiments of the invention without departing from the true spirit and scope of the invention.

What is claimed is:

1. A navigation system, comprising:
a commercial mobile service provider (CMSP) gateway in an emergency alerting system, said CMSP gateway including:
a plurality of active emergency alerting system alerts, and
a plurality of weather radar data; and
a display adapted to display a visual representation of an active one of said plurality of active emergency alerting system alerts and at least one of said plurality of weather radar data.

2. The navigation system according to claim 1, wherein:
said display includes a visual representation depicting respective coverage areas emitted by a plurality of cell sites located in an active alert area.

3. The navigation system according to claim 1, wherein:
said display further displays current weather patterns on a map.

4. The navigation system according to claim 1, wherein:
said navigation system includes a user option to pan and zoom said display to a view weather pattern in another area.

5. A method for performing navigation redirect around an active alert area, comprising:
receiving alert information from a commercial mobile service provider (CMSP) gateway in an emergency alerting system;
instructing a session manager device to update an alert database with said alert information;
determining that an alert area defined in said alert information intersects an active navigation session;
instructing a navigation engine to reroute said active navigation session to avoid said alert area;
returning updated route information to said session manager; and
updating said active navigation session with said route information on a navigating subscriber device.

6. The method for performing navigation redirect around an active alert area according to claim 5, wherein said alert information comprises:
an alert type;
an alert expiration;
a recommended action; and
an alert area.
